(19) United States
(12) Patent Application Publication
(10) Pub. No.: US 2025/0265511 A1
(43) Pub. Date: Aug. 21, 2025

(54) DISTRIBUTED AGENTIC SYSTEM FOR HANDLING REQUESTS SPECIFIC TO OPERATIONS AND METHOD THEREOF

(71) Applicant: Accenture Global Solutions Limited, Dublin (IE)

(72) Inventors: Ryan OLOHAN, Kildare (IE); Madhusudhan SRIVATSA CHAKRAVARTHI, Lisbon (PT); Darach Francis ÓSÚILLEABHÁIN, Claremorris (IE); Ajit FERRAO, Mumbai (IN); Andrew Jarvis SMITH, Austin, TX (US); Dean Christopher TREJO, Matthews, NC (US)

(73) Assignee: Accenture Global Solutions Limited, Dublin (IE)

(21) Appl. No.: 19/049,710

(22) Filed: Feb. 10, 2025

Related U.S. Application Data
(60) Provisional application No. 63/554,342, filed on Feb. 16, 2024.

(51) Int. Cl. G06Q 10/0631

(52) U.S. Cl. CPC G06Q 10/0631

(57) ABSTRACT

Method, system, and computer program product are disclosed for handling requests specific to operations using a distributed agentic framework. A method includes identifying at least one micro-agent of the plurality of micro-agents to handle a request. The request is specified in a user input. The method includes generating a prompt corresponding to the request specified in the user input and routing the prompt to the at least one micro-agent of the plurality of micro-agents. The method includes performing at least one operation, specific to the request, using the at least one micro-agent of the plurality of micro-agents, to generate a response for the prompt. The method includes evaluating the response by comparing the response with an anticipated response. Upon evaluating that the response meets or exceeds a predetermined threshold criterion, the method includes providing the response as an output to the user input.

### CROSS-REFERENCE TO RELATED APPLICATIONS

This application claims the benefit of priority to U.S. Provisional Patent Application No. 63/554,342, filed on Feb. 16, 2024, the entirety of which is incorporated by reference herein.

### TECHNICAL FIELD

Various examples described herein generally relate to method, system, and computer program product for handling requests specific to operations by identifying and utilizing a sub-set of micro-agents from a set of micro-agents.

### BACKGROUND

Enterprises continuously seek to improve and gain efficiencies in their operations. To this end, enterprises employ software systems to support execution of tasks or operations. Enterprises integrate the software systems in the domain of an intelligent enterprise, which employs Artificial Intelligence (AI) that may include, for example, machine learning (ML) models. AI can be used for data analytics and/or automating tasks in support of enterprise operations.

In the field of AI, Generative AI (GAI) has recently seen an explosion in popularity. The increasing power and popularity of GAI has seen enterprises seeking avenues to leverage GAI in improving the enterprise operations. GAI includes Large Language Models (LLMs), which may be used to generate text for a variety of use cases. In some examples, the LLMs may be integrated in digital assistants (e.g., chatbots), replacing traditional rule-based systems, to generate the text as a response to a user input.

### SUMMARY

Implementations of the present disclosure provide a distributed agentic framework for identifying a sub-set of micro-agents from a set of micro-agents for a request and performing one or more operations specific to the request using the identified sub-set of micro-agents. Therefore, the one or more operations may be performed with a high degree of flexibility and accuracy.

In at least one example, the present disclosure provides a computer-implemented method for handling requests specific to operations using a distributed agentic framework. The method includes identifying at least one micro-agent of the plurality of micro-agents to handle a request. The request is specified in a user input. The method includes generating a prompt corresponding to the request specified in the user input and routing the prompt to the at least one micro-agent of the plurality of micro-agents. The method includes performing at least one operation, specific to the request, using the at least one micro-agent of the plurality of micro-agents, to generate a response for the prompt. The method includes evaluating the response by comparing the response with an anticipated response. Upon evaluating that the response meets or exceeds a predetermined threshold criterion, the method includes providing the response as an output to the user input.

The present disclosure further describes a system for implementing the method provided herein. The present disclosure also describes a non-transitory computer-readable storage media (CRM) having instructions stored thereon which, when executed by one or more processors of a computing device, cause the computing device to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment used to execute implementations of the present disclosure.

FIG. 2 depicts an example architecture of a distributed agentic system disclosed in the example environment of FIG. 1, for handling requests, in accordance with implementations of the present disclosure.

FIG. 3 depicts an example conceptual architecture of an agentic based request handler disclosed in the distributed agentic system of FIG. 2, for handling the requests, in accordance with implementations of the present disclosure.

FIG. 4 depicts an example process flow of generating an output by processing a request specified in a user input using a sub-set of micro-agents, in accordance with implementations of the present disclosure.

FIG. 5 depicts an example illustration of executing the sub-set of micro-agents based on an orchestration, in accordance with implementations of the present disclosure.

FIG. 6 depicts an example illustration of handling the request specified in the user input using the sub-set of micro-agents, in accordance with implementations of the present disclosure.

FIG. 7 is a flow diagram that presents an example computer implemented method for handling requests using a distributed agentic framework, in accordance with implementations of the present disclosure.

FIG. 8 depicts an example computer system to implement the distributed agentic system disclosed in the example environment of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality or acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

With the advent of Generative Artificial Intelligence (GAI), enterprises are adopting GAI to support execution of various operations or tasks. For example, GAI may support communications or conversations, and processes in software systems to support decision-making within the enterprises. Multiple applications within an enterprise network environment may use and interact with foundation models or Large Language Models (LLMs) of GAI to provide input and/or data for execution of the tasks such as human computer interactions (e.g., question and answering), customer service automation, automating process execution, process planning, generating step-by-step procedures for the process execution, performing data analysis, and/or the like. Due to the capability of processing the unstructured data, the LLMs may be implemented for various domains and applications of GAI such as software engineering, computational biology, healthcare or medicine, marketing, and/or the like. However, usage of the LLMs for the various domains and applications is a non-trivial task.

The enterprises may employ application frameworks to assist with the usage of the LLMs for the various domains and applications. Existing application frameworks may include monolithic agentic frameworks, where all functionalities or tools to execute the various operations are encapsulated within a single agent supported by an LLM. However, due to encapsulation of all the functionalities or tools within the single agent, the single agent may be prone to hallucinations (which may be described as errors, inaccuracies, and/or untruths in an output) as well as erroneous usage of the functionalities or tools. Further, due to encapsulation of all the functionalities or tools, the monolithic agentic frameworks may fail to satisfy demands of scalability. For example, performance of the monolithic agentic frameworks may degrade to unacceptable levels when attempting to scale an input that is to be processed. By way of non-limiting example, the input may include text that is composed of tokens. With an increase in the number of tokens, the performance of the monolithic agentic frameworks may degrade as the single agent may fail to efficiently process the increased number of tokens. Further, updating the functionalities or tools in the single agent may be challenging and time consuming, which may increase instability of the monolithic agentic frameworks and make the monolithic agentic frameworks rigid and incapable to adapt to new domains and applications of GAI. Therefore, the monolithic agentic frameworks may fail to satisfy demands of maintainability and flexibility. Further, an error caused in any of the functionalities or tools encapsulated in the single agent may cause the entire monolithic agentic frameworks to fail, impacting reliability and availability.

In some examples, the monolithic agentic frameworks may require long-context prompts (e.g., prompts with a large number of tokens) to execute the single agent, as the prompts are required to include all instructions and Retrieval-Augmented Generation (RAG) content. A response generated using such long-context prompts may lack accuracy and details.

Therefore, the monolithic agentic frameworks may expend a significant amount of time, human resources, and computing resources (e.g., processing resources, memory resources, communication resources, and/or the like) to generate the response for the input.

Implementations of the present disclosure provide a distributed agentic framework, where a set of micro-agents may be employed to handle requests specific to various operations that are related to various domains and applications of GAI. Each micro-agent in the set of micro-agents may be supported by an LLM and encapsulated with a specific functionality or tool, which may enable a respective micro-agent to perform a specific operation. Therefore, the proposed distributed agentic framework may satisfy demands of scalability, maintainability, and flexibility.

Further, the distributed agentic framework may include an orchestration layer, an agent layer, and a response layer. The orchestration layer receives a request specified in a user input. Upon receiving the request, the orchestration layer identifies, from the set of micro-agents, one or more micro-agents (e.g., a sub-set of micro-agents) that are to be used for the request and an orchestration indicating an order of executing the one or more micro-agents. The agent layer executes the one or more micro-agents in accordance with the orchestration to perform respective one or more designated operations specific to the request, generates respective sub-responses from execution of the one or more micro-agents, and provides the sub-responses as a response to the response layer. The response layer evaluates the response and accordingly determines a status of evaluation as “success” or “failure.” Upon determining the status of evaluation as “success,” the response layer provides the response as a final output to the user input. Upon determining the status of evaluation as “failure,” the response layer provides feedback to the orchestration layer to identify new micro-agents and a new orchestration, which may be used to perform another iteration of processing the request responsive to the feedback. Such iterations may continue until the response layer determines that the status of evaluation is “success,” and accordingly the final output may be provided to the user input. Therefore, the proposed distributed agentic framework may provide self-correction and autonomous orchestration of the one or more micro-agents, which may aid in generation of the response with improved accuracy and with reduced time and computing resources requirements.

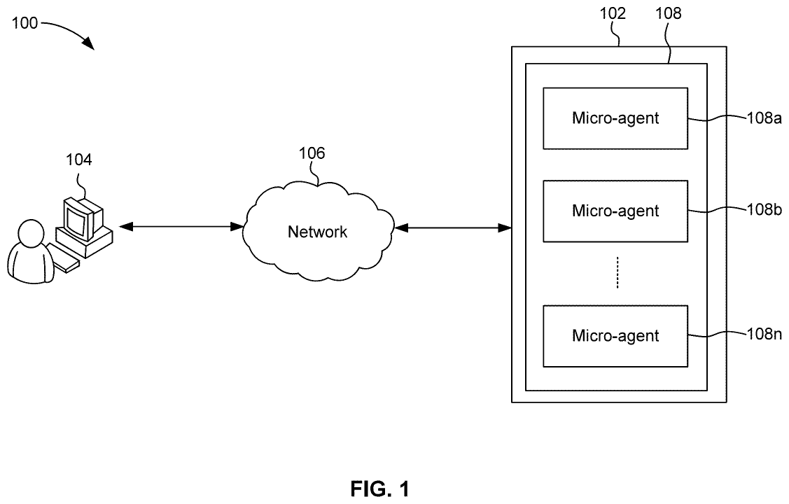

FIG. 1 depicts an example environment 100 used to execute implementations of the present disclosure. The example environment 100 may enable handling of requests specific to operations. In some examples, the operations may indicate tasks related to various domains and applications of Generative Artificial Intelligence (GAI) such as human computer interaction-based applications (e.g., question and answering applications), applications for automating enterprise operations, software development, customer service automation, computational biology, healthcare, medicine, content delivery, e-commerce applications, and/or any other applications where text-in and text-out is a modality (e.g., knowledge management in chat-bot applications).

The example environment 100, depicted in FIG. 1, includes a distributed agentic system 102 and a user device 104. In the present disclosure, the distributed agentic system 102 may also be referenced as a system, a micro-agent system, and/or the like. The distributed agentic system 102 may communicate with the user device 104 using a network 106. In some examples, the network 106 may include a Local Area Network (LAN), a Wide Area Network (WAN), the Internet, or a combination thereof. In some examples, the network may be accessed over a wired and/or a wireless communication link.

The user device 104 may be associated with a user, a client, an administrator, and/or an entity (e.g., an enterprise, an organization, and/or the like). In some examples, the user device 104 may include a desktop, smartphones, laptops, a tablet, and/or the like. The user device 104 may present one or more user interfaces (e.g., Graphical User Interfaces (GUIs)) of a workspace for the user to interact with the distributed agentic system 102. The user device 104 may be used to provide user input and/or receive output to/from the distributed agentic system 102. The user input may indicate requests to be handled. The output may include responses corresponding to the requests.

The distributed agentic system 102 may be implemented as an on-premises system that is operated by an enterprise or a third-party engaged in cross-platform interactions and operations management. In some examples, the distributed agentic system 102 may be implemented as an off-premises system (for example, cloud or on-demand) that is operated by the enterprise or a third-party on behalf of the enterprise. In some examples, the distributed agentic system 102 may be implemented in a cloud environment. For simplicity, the distributed agentic system 102 depicted in FIG. 1 may be a cloud based distributed agentic system that is intended to represent various forms of servers including a web server, an application server, a proxy server, a network server, a server pool, and/or the like.

In accordance with implementation of the present disclosure, the distributed agentic system 102 may employ a distributed agentic framework. The distributed agentic framework may include a set of micro-agents 108 for handling the requests. The set of micro-agents may include micro-agents 108a-108n. Each of the micro-agents 108a-108n may be configured to perform a designated operation. Therefore, the micro-agents 108a-108n may include simple, operation oriented, and independent agents.

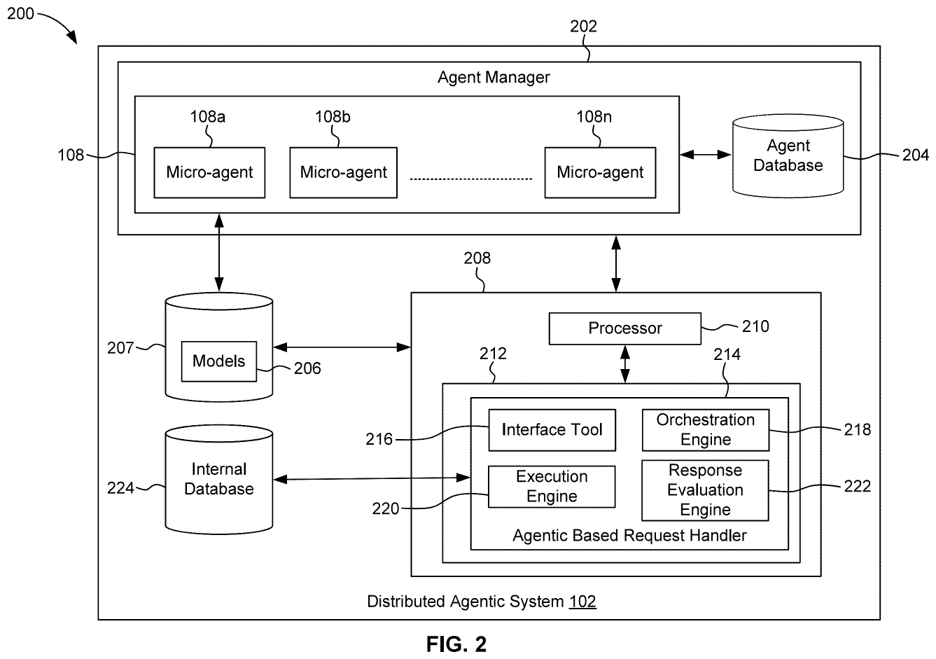

Upon receiving the requests, for example, from the user device 104, the distributed agentic system 102 may identify a sub-set of micro-agents from the set of micro-agents 108 for each of the requests. The distributed agentic system 102 may execute the sub-set of micro-agents to generate a response corresponding to each of the requests. Various examples depicting handling of the requests using the distributed agentic framework is described in detail in conjunction with FIGS. 2-8.

FIG. 2 depicts an example architecture 200 of the distributed agentic system 102 disclosed in the example environment of FIG. 1, for handling the requests, in accordance with implementations of the present disclosure. As depicted in FIG. 2, the distributed agentic system 102 employed with the distributed agentic framework includes an agent manager 202.

The agent manager 202 includes the set of micro-agents 108 and an agent database 204. In the present disclosure, the set of micro-agents 108 may also be referenced as a pool of micro-agents, a chain of micro-agents, a superset of micro-agents, and/or the like. The set of micro-agents 108 includes the micro-agents 108a-108n. Each of the micro-agents 108a-108n may be created or configured by the agent manager 202 to perform a respective designated operation (e.g., a task). Examples of the operation may include, but are not limited to, generating a content by answering a question, providing information about products and/or services, providing technical assistance related to products and/or services, auditing questions and responses, scheduling appointments, performing logical and mathematical computations, process planning, generating step-by-step procedures for the process execution, performing data analysis, processing media (e.g., an image, a video, audio, and/or the like), developing a code, testing the code, persona generation, coaching a user about the products and/or services, and/or the like.

In some examples, each of the micro-agents 108a-108n may be created and configured based on the domain and applications for which the micro-agents 108a-108n are being deployed. In one example, for an application like customer service automation, the micro-agents 108a-108n may include agents such as a summarization agent, an audit agent, a logic agent, a mathematical agent, a fact checking agent, a rubric scoring agent, and a style guide agent. The summarization agent, the audit agent, the logic agent, the mathematical agent, the fact checking agent, the rubric scoring agent, and the style guide agent may be configured for performing respective operations such as answering questions related to tickets raised for products and/or services, auditing queries and responses, providing detailed step-by-step procedures to resolve the tickets, performing calculations, performing fact checking on information accessed from different data sources (not shown in FIG. 2) related to the products and/or services, computing a rubric score for the responses, performing style guide criteria matching, and/or the like. In another example, for the application like travel planning, the micro-agents 108a-108n may include a flight agent to book flights, a hotel agent to search hotels, a transportation agent to arrange transportation for a travel, and an activity agent to book activities, events, respectively.

In some examples, creating or configuring a micro-agent of the micro-agents 108a-108n may include encapsulating a functionality or tool required to perform the respective designated operation in the micro-agent and training the micro-agent to perform the respective designated operation. Therefore, the distributed agentic framework may separate functionalities or tools, so that each of the micro-agents 108a-108n may not be required to decide on any functionalities or tools for performing the respective operation. Due to which, performance of the micro-agents 108a-108n may be improved. In some examples, the functionality and tool encapsulated in the micro-agent may enable the micro-agent to access a model from models 206 stored in a model database 207 for performing the designated operation. In some examples, the models 206 may include Large Language Models (LLMs). While implementations of the present disclosure are described with non-limiting reference to the LLMs, it is contemplated that implementations of the present disclosure may be realized using any appropriate foundation models, or Machine Learning (ML) models, or Artificial Intelligence (AI) models, or fine-tuned models, or Small Language Models (SLMs). In some examples, the models 206 may include a combination of LLMs and non-LLM based tools. By way of non-limiting example, the non-LLM based tools may include a web search Application Programming Interfaces (APIs), image generation tools, graphic design tools, and/or the like. Therefore, with the encapsulated functionality or tool, the micro-agent may access the LLM or a non-LLM based tool to perform the designated operation. In some examples, the micro-agents 108a-108n may be operated as code execution agents.

The agent database 204 may store agent information about each of the micro-agents 108a-108n in the set of micro-agents 108. By way of non-limiting example, the agent information about the micro-agent may include a name of the micro-agent, a description of the micro-agent, an expected input to the micro-agent, an expected output from the micro-agent, one or more upstream micro-agents (if any) for the micro-agent, one or more downstream micro-agents (if any) for the micro-agent, and/or the like. The description of the micro-agent may include natural language description or definition. The description of the micro-agent may indicate an operation, or a role being performed by the micro-agent. The expected input to the micro-agent may indicate a number of tokens or a length of tokens to be present in a prompt to be inputted to the micro-agent, a type of the prompt to be inputted to the micro-agent, and/or the like. The expected output from the micro-agent may indicate a length of tokens to be present in a response to be received from the micro-agent, a type of response to be received from the micro-agent, and/or the like. The one or more upstream micro-agents for the micro-agent may indicate micro-agents that have connectivity with the respective micro-agent and further that are required to be executed before executing the respective micro-agent. The one or more downstream micro-agents for the micro-agent may indicate micro-agents that have connectivity with the respective micro-agent and further that are required to be executed after executing the respective micro-agent.

Still referring to FIG. 2, the distributed agentic system 102 includes a computing device 208 for handling requests by accessing the set of micro-agents 108 and the agent information from the agent database 204. In some examples, the computing device 208 may be implemented by way of a single device or a combination of multiple devices that may be operatively connected or networked together. The computing device 208 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, or other suitable software structures operating in one or more software applications.

The computing device 208 includes a processor 210 and a memory 212 communicably coupled to the processor 210. The processor 210 may include one or more processors. Examples of the processor 210 may include, but are not limited to, microprocessors, microcomputers, microcontrollers, digital signal processors, central processing units, state machines, logic circuits, and/or any devices that manipulate data or signals based on operational instructions. Among other capabilities, the processor 210 may fetch instructions (also be referenced to as processor-executable instructions or machine-executable instructions) from the memory 212 and execute the fetched instructions for performing functions according to the present disclosure. The memory 212 may be non-volatile or non-transitory computer-readable medium (CRM) such as, a magnetic disk or solid-state non-volatile memory or volatile medium such as Random Access Memory (RAM), and/or the like. Further, the computing device 208 includes an agentic based request handler 214. The agentic based request handler 214 may be stored in the memory 212 and provided as a downloadable library including the instructions. The agentic based request handler 214 includes an interface tool 216, an orchestration engine 218, an execution engine 220, and a response evaluation engine 222. The processor 210 may execute the interface tool 216, the orchestration engine 218, the execution engine 220, and the response evaluation engine 222 to handle the requests, which is described in detail below.

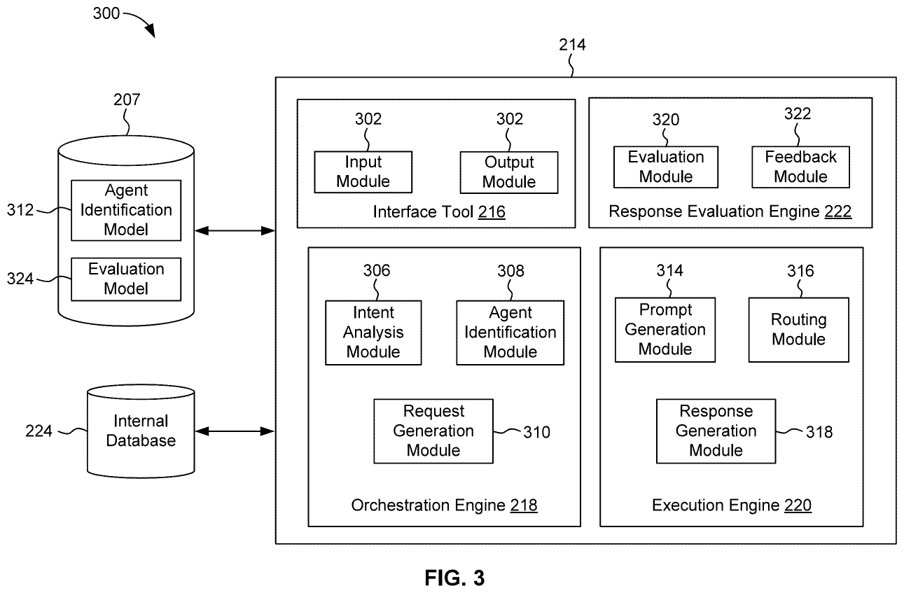

In some examples, as depicted in FIG. 2, the agentic based request handler 214 may be further communicatively coupled with an internal database 224, which may store various data and intermediate results generated by the interface tool 216, the orchestration engine 218, the execution engine 220, and the response evaluation engine 222. It should be noted that the memory 212 and/or the internal database 224 may be shared across the set of micro-agents 108 and the components 216-222 of the agentic based request handler 214. The interface tool 216, the orchestration engine 218, the execution engine 220, and the response evaluation engine 222 are described in detail in conjunction with an example conceptual architecture 300 of the agentic based request handler 214 depicted in FIG. 3.

As depicted in FIG. 3, the interface tool 216 includes an input module 302 and an output module 304. In some examples, the input module 302 and the output module 304 may represent one or more interfaces of a chatbot application. The chatbot application may be executing on the user device 104 (depicted in FIG. 1) for receiving a user input and providing an output for the user input, respectively. In some examples, the user input may be received through various modalities such as text, voice, and/or the like. The user input may include a request specific to one or more operations to be performed. The output for the user input may include a response for the request. The output may be generated by operating the orchestration engine 218, the execution engine 220, and the response evaluation engine 222 in conjunction with each other, which is described in detail below.

The orchestration engine 218 (also be referenced as an orchestration layer) may identify one or more micro-agents from the set of micro-agents 108 (depicted in FIGS. 1 and 2) for handling the request specified in the user input. The identified one or more micro-agents may act as a sub-set of the set of micro-agents 108. In some examples, the orchestration engine 218 may identify the one or more micro-agents for handling the request based on analysis of an intent of the user input. Therefore, according to the present disclosure, the orchestration engine 218 does not act on the user input (e.g., does not perform preprocessing the user input) other than analyzing the intent of the user from the user input. For example, the orchestration engine 218 may not preprocess the user input to correct any spelling mistakes, formatting errors, typographical errors, and/or the like, present in the user input. For example, as depicted in FIG. 3, the orchestration engine 218 includes an intent analysis module 306, an agent identification module 308, and a request generation module 310.

The intent analysis module 306 may determine the intent of the user based on the user input. The intent of the user may indicate a purpose of the request specified in the user input. The purpose may include a single purpose, multiple purposes, and/or the like. By way of non-limiting example, the intent corresponding to the single purpose may indicate an operation like providing technical assistance regarding a product to a customer. The intent corresponding to the multiple purposes may indicate operations such as providing the technical assistance regarding the product and coaching or training the user to assist the customer. The intent analysis module 306 may also classify the intent into a class from a set of classes. For example, if the user input includes “I need to close my saving account,” the intent may include identifying a relevant procedure for closing the saving account of the user. The class associated with such an intent may include “savings,” “close,” and/or the like.

In some examples, the intent analysis module 306 may determine and classify the intent of the user by evaluating the user input through its verbatim definitions. In some other examples, the intent analysis module 306 may determine and classify the intent of the user based on a context of a conversation being facilitated with the user (e.g., previous requests received before the user input) and/or the user input. The context may indicate an intent or purpose associated with each of the previous requests. In some other examples, the intent analysis module 306 may use Retrieval-Augmented Generation (RAG) techniques to determine and classify the intent based on the user input. The intent analysis module 306 may provide the intent of the user and the respective class to the agent identification module 308.

The agent identification module 308 may identify the one or more micro-agents from the set of micro-agents 108 for the request specified in the user input. The agent identification module 308 may identify the one or more micro-agents for the request based on the intent of the user and the respective class.

For identifying the one or more micro-agents, the agent identification module 308 may access the agent information about each micro-agent in the set of micro-agents 108 (depicted in FIG. 2). The agent information about a micro-agent may include a name of the micro-agent, a description of the micro-agent, an expected input to the micro-agent, an expected output from the micro-agent, one or more upstream micro-agents (if any) for the micro-agent, one or more downstream micro-agents (if any) for the micro-agent, and/or the like. The agent identification module 308 may generate a relevance score for each micro-agent in the set of micro-agents 108 by performing semantic similarity on the agent information of the respective micro-agent with respect to the intent of the user and the respective class. Therefore, the relevance score of the micro-agent may be based on a vector distance between the agent information of the respective micro-agent and the intent of the user and the respective class. Based on the relevance score of each micro-agent in the set of micro-agents 108, the agent identification module 308 may identify the one or more micro-agents, from the set of micro-agents 108, for handling the request specified in the user input. For example, the agent identification module 308 may identify names or identifiers of the one or more micro-agents for handling the request.

In some examples, the agent identification module 308 may use an agent identification model 312 stored in the model database 207 for identifying the one or more micro-agents for handling the request specified in the user input. By way of non-limiting example, the agent identification model 312 may include an AI model, an LLM, a ML model, and/or the like. To illustrate, the agent identification module 308 may provide the relevance score of each micro-agent in the set of micro-agents 108, the intent of the user, and/or the user input to the agent identification model 312. Further, the agent identification module 308 may enable the agent identification model 312 to generate an outcome by processing the relevance score of each micro-agent with respect to the intent of the user, and/or the user input. The outcome may identify the one or more micro-agents for handling the request. In some examples, the agent identification module 308 may use a “grammar” tool to mask output logits of possible generated tokens, thereby limiting the outcome of the agent identification model 312 to only valid names of the one or more micro-agents as stored in the agent database 204. The output logits of the possible generated tokens may refer to a raw or unprocessed form of the outcome generated using the agent identification model 312. Herein, the tokens may refer to words in a text of the outcome generated by the agent identification model 312.

Additionally, or alternatively, the agent identification module 308 may determine an orchestration for the identified one or more micro-agents. The orchestration may indicate an order describing how the one or more micro-agents to be executed or processed or how the one or more micro-agents to be prompted relative to one another (e.g., with respect to each other) for handling the request. In some examples, the orchestration may indicate a sequential execution (also be referenced as a series execution), and/or a parallel asynchronous execution, and/or a single instance execution, and/or a function-based execution, and/or a combination thereof. The sequential execution may indicate execution or processing of the one or more micro-agents in a sequential manner. In some examples, the parallel asynchronous execution may indicate execution or processing of the one or more micro-agents in parallel and combining of all sub-responses generated from execution of the one or more micro-agents, thereby consolidating the sub-responses of the one or more micro-agents. Therefore, the parallel asynchronous execution may act as an asynchronous chain and/or a bespoke chain of the one or more micro-agents. In some other examples, the parallel asynchronous execution may indicate execution or processing of the one or more micro-agents in parallel without consolidating the sub-responses of the one or more micro-agents. The single instance execution may indicate execution or processing of the one or more micro-agents as a single instance. For example, if the four micro-agents are identified for the request, then the four micro-agents are considered as a single agent for execution or processing in accordance with the single instance execution. The function-based execution may indicate execution or processing of the one or more micro-agents as functions for a pre-defined function loop.

In some examples, the agent identification module 308 may identify that none of the micro-agents from the set of micro-agents 108 are available for handling the request, based on their relevance score. By way of non-limiting example, if the relevance scores of the micro-agents in the set of micro-agents 108 are zero or if the agent identification model 312 fails to provide any outcome, the agent identification module 308 may identify that none of the micro-agents from the set of micro-agents 108 are available for handling the request. In such a scenario, the agent identification module 308 may enable the request generation module 310 to generate an agent request.

The request generation module 310 may generate the agent request for the agent manager 202 (depicted in FIG. 2) to create and configure one or more new micro-agents to handle the request specified in the user input. In some examples, the agent manager 202 may invoke a predefined agent generation workflow and use the agent generation workflow to create an appropriate prompt and instructions to handle the request. The predefined agent generation workflow may act as a guide to create and configure the one or more new micro-agents. Based on the created appropriate prompt and instructions, the agent manager 202 may create and configure the one or more micro-agents (e.g., creating one or more new instances of micro-agents). In some other examples, the agent manager 202 may configure the one or more new micro-agents to handle the request by receiving an agent input from an administrator or a developer of the enterprise. The agent input received from the administrator or developer of the enterprise may indicate a step-by-step procedure of generating the one or more new micro-agents. Upon creating and configuring the one or more new micro-agents, the agent manager 202 may add the one or more new micro-agents to the set of micro-agents 108 and add the agent information for each of the one or more new micro-agents in the agent database 204 (depicted in FIG. 2). Further, the agent identification module 308 may determine the orchestration for execution or processing the one or more new micro-agents (as described above).

The agent identification module 308 may store information about the one or more micro-agents (including the one or more new micro-agents) identified for handling the request and the orchestration of the one or more micro-agents in the internal database 224. In addition, the agent identification module 308 may provide the user input, names or identifiers of the one or more micro-agents (including the one or more new micro-agents) identified for handling the request specified in the user input, the orchestration of the one or more micro-agents, and instructions for executing or processing the one or more micro-agents to the execution engine 220. The instructions may indicate the agent information about each of the one or more micro-agents identified for handling the request. The agent information about a micro-agent may include a description of the micro-agent, an expected input to the micro-agent, an expected output from the micro-agent, one or more upstream micro-agents (if any) for the micro-agent, one or more downstream micro-agents (if any) for the micro-agent, and/or the like.

The execution engine 220 (also be referenced as an execution layer) may generate a response using the one or more micro-agents identified for handling the request. As would be understood, the execution engine 220 may access the set of micro-agents 108 and the agent database 204 of the agent manager 202. For example, as depicted in FIG. 3, the execution engine 220 includes a prompt generation module 314, a routing module 316, and a response generation module 318.

The prompt generation module 314 may generate a prompt for the request specified in the user input. In some examples, the prompt may include one or more prompts corresponding to the one or more micro-agents identified for handling the request. In some examples, the prompt generation module 314 may use predefined prompt templates (e.g., boilerplate templates) for generating the prompt for the request. In some other examples, the prompt generation module 314 may use any suitable prompt generation or prompt format engineering techniques to generate the prompt for the request.

The routing module 316 may route the prompt including the one or more prompts to the respective one or more micro-agents identified for handling the request. In some examples, the routing module 316 may route the prompt including to the one or more prompts to the respective one or more micro-agents through an Application Programming Interface (API).

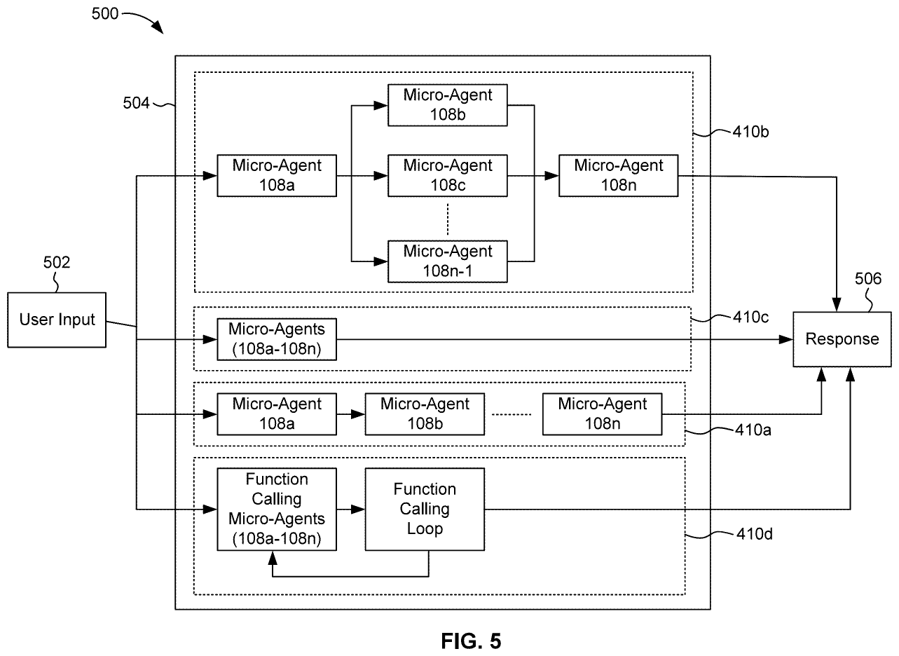

The response generation module 318 may generate the response using the one or more micro-agents identified for handling the request specified in the user input. For generating the response, the response generation module 318 may perform the one or more operations specific to the request using the respective one or more micro-agents. Performing the one or more operations using the respective one or more micro-agents may refer to executing or processing the one or more micro-agents based on the prompt. The prompt may include the request specified in the user input, names or identifiers of the one or more micro-agents, and the orchestration and instructions for executing the one or more micro-agents. For example, the one or more micro-agents may be executed or processed based on the orchestration and the instructions received from the orchestration engine 218 (e.g., from the agent identification module 308 of the orchestration engine 218). The orchestration may include the sequential execution, the parallel asynchronous execution, the single instance execution, and the function-based execution. An example illustration of executing the one or more micro-agents in accordance with the orchestration is depicted in FIG. 5.

Executing or processing the one or more micro-agents may include enabling the one or more micro-agents to perform the one or more operations based on the routed one or more prompts. In some examples, the one or more micro-agents may invoke one of the models 206 from the model database 207 (depicted in FIG. 2) to perform the designated one or more operations by processing the request specified in the user input. The models 206 may include the LLM, or a combination of the LLM and the non-LLM based tool. For example, each of the one or more micro-agents may provide a respective prompt to one of the models 206 through an API and receive a sub-response (e.g., an intermediate answer) from a respective model. In some other examples, the one or more micro-agents may perform the respective one or more operations without invoking any of the models 206 from the model database 207. By way of non-limiting example, a mathematical agent may perform required calculations on the user input without invoking any of the model.

Further, executing or processing the one or more micro-agents may result in generation of respective one or more sub-responses (also be referenced as one or more intermediate answers). Based on the one or more sub-responses, the response generation module 318 may generate the response. In some examples, the response may include the one or more sub-responses individually. In some other examples, the responses may include a combination or consolidation of the one or more sub-responses. The one or more sub-responses may be combined or consolidated based on the orchestration used to execute or process the respective one or more micro-agents. By way of non-limiting example, if the orchestration indicates the parallel asynchronous execution, the response generation module 318 may combine or consolidate the one or more sub-responses to generate the response. The response generation module 318 may store the response including the one or more sub-responses in the internal database 224. Additionally, or alternatively, the response generation module 318 may provide the response to the response evaluation engine 222.

The response evaluation engine 222 (also be referenced as a response layer) may evaluate the response to provide an output to the user input. For example, as depicted in FIG. 3, the response evaluation engine 222 includes an evaluation module 320 and a feedback module 322.

The evaluation module 320 may evaluate the response and accordingly provide the output to the user input. The evaluation module 320 may evaluate the response with an anticipated response. The anticipated response may be a default response determined based on the user input. In some examples, the evaluation module 320 may use an evaluation model 324 from the model database 207 to evaluate the response with the anticipated response. By way of non-limiting example, the evaluation model 324 may include an LLM, an AI model, a ML model, and/or the like. In some examples, the response may be evaluated with the anticipated response in terms of evaluation parameters such as clarity, relevance, fact checks, output formats of the response, tone of the response, a style of the response, score evaluations, and/or the like. The clarity may indicate whether the response is clear and specific. The relevance may indicate whether the response is related to the domain and application associated with the request specified in the user input. The fact checks may indicate whether the response includes any untruths or incorrect information. The output formats may indicate whether the response is generated in an output format specified by the user in the request. The output format may include text, audio, an image, a video, and/or the like. The style of the response may indicate whether the response is conformed to a style predefined by the user. The score evaluations may indicate whether a score (e.g., a rubric score) computed for the response is valid or not.

Based on the evaluation, the evaluation module 320 may determine whether the response meets or exceeds a predetermined threshold criterion. The predetermined threshold criterion may indicate a criterion required to determine whether the response satisfies the anticipated response. For example, consider the predetermined threshold criterion indicating that the response is required to satisfy the anticipated response in terms of the evaluation parameters such as the clarity, the fact checks, the style, and the rubric score. In such a scenario, if the response is clear and specific without including any untruths and conformed to the predefined style, and the score computed for the response is valid, the evaluation module 320 may determine that the response meets or exceeds the predetermined threshold criterion, thereby satisfying the anticipated response or user input. If the response is not clear and specific, or the response includes untruths, or the response includes invalid score, or the response is not conformed to the predefined style, the evaluation module 320 may determine that the response fails to meet or exceed the predetermined threshold criterion, thereby the response fails to satisfy the anticipated response or the user input.

When it has been determined that the response meets or exceeds the predetermined threshold criterion, the evaluation module 320 may determine a status of evaluation as “success” and determine to provide the response as the output (e.g., a final output) to the user input. The output or response may include an answer derived from performing the one or more operations specific to the request specified in the user input. The evaluation module 320 may store the output in the internal database 224 and/or provide the output on a user interface of the user device 104 through the output module 304 of the interface tool 216. When it has been determined that the response fails to meet or exceed the predetermined threshold criterion, the evaluation module 320 may determine a status of evaluation as “failure.” The evaluation module 320 may provide the status of evaluation determined as “failure” to the feedback module 322.

The feedback module 322 may generate feedback, when the status of evaluation is determined as “failure.” The feedback may indicate a reason for determining the status of evaluation as “failure” and inputs for refining the response. The inputs may indicate the one or more micro-agents with low performance, a quality of the prompt used for execution or processing the one or more micro-agents, and recommendations or improvements required for refining the response. The recommendations or improvements may indicate requirements for identifying new micro-agents and generating a new orchestration, a new prompt, and/or the like. The feedback module 322 may log the feedback in the internal database 224 with respect to the response.

Upon logging the feedback, the feedback module 322 may enable the orchestration engine 218, the execution engine 220, and the evaluation module 320 to operate in conjunction with each other to iteratively generate new responses and evaluate new responses, for a pre-defined number of iterations or until the status of evaluation is determined as “success.” For example, in each iteration, (i) the agent identification module 308 of the orchestration engine 218 may identify one or more other micro-agents from the set of micro-agents 108 for the request and a new orchestration for executing or processing the identified one or more other micro-agents based on the feedback, (ii) the prompt generation module 314 of the execution engine 220 may generate an updated prompt including one or more updated prompts for the respective one or more other micro-agents, (iii) the response generation module 318 of the execution engine 220 may generate a new response by executing the one or more other micro-agents based on the updated prompts and the new orchestration, and (iv) the evaluation module 320 may evaluate the new response and determine the status of evaluation. If the status of evaluation is “failure,” the feedback module 322 may regenerate feedback for a next iteration of generating a new response.

In some examples, in each iteration, the agent identification module 308 may use the feedback to identify the one or more micro-agents with the low performance (e.g., the one or more micro-agents that fail to efficiently perform the operations in a previous iteration) and accordingly identify the one or more other micro-agents and the respective new orchestration. In some examples, in each iteration, the prompt generation module 314 may generate the updated prompt using a RAG process. In accordance with the RAG process, the updated prompt may be generated based upon historical chat transcription and multiple fined-tuned Llama 2 model parameters stored in the internal database 224 or in the memory 212 (e.g., a persistent memory).

In some examples, the feedback module 322 may log or store iteration information in the internal database 224 for the user input or the request specified in the user input. The iteration information may indicate the number of iterations performed to provide the output to the user input. The iteration information may be used by the feedback module 322 to provide recommendations on improving the set of micro-agents 108 or redesigning the orchestration of the micro-agents.

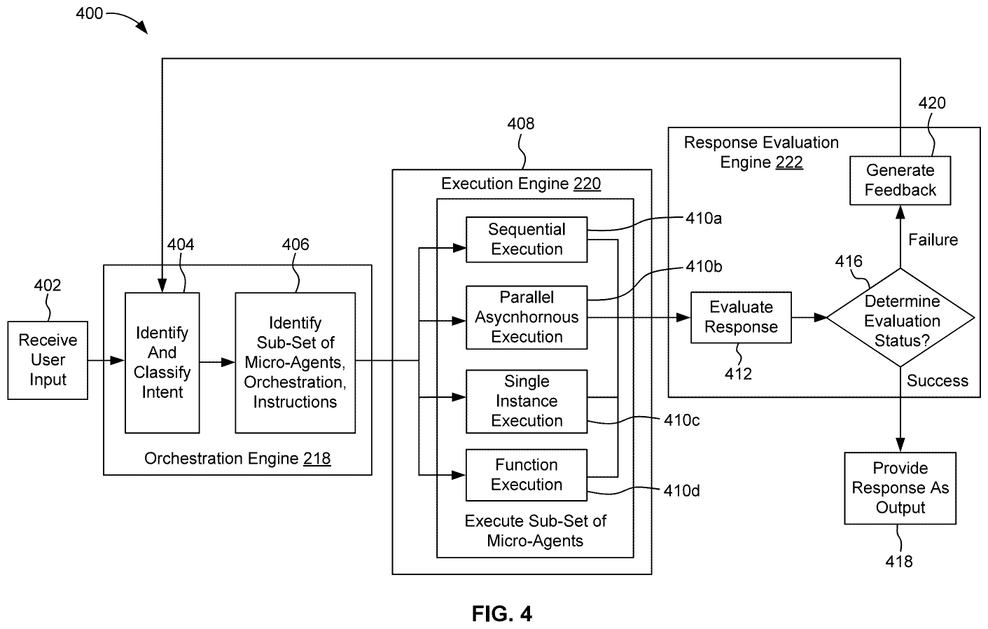

FIG. 4 depicts an example process flow 400 of generating an output by processing a request specified in a user input using a sub-set of micro-agents, in accordance with implementations of the present disclosure. The process flow 400 may be executed using the interface tool 216, the orchestration engine 218, the execution engine 220, and the response evaluation engine 222 of the agentic based request handler 214 as described in relation to FIGS. 2 and 3.

The interface tool 216 receives 402 a user input from a user through the user device 104 (depicted in FIG. 1). The user input may specify a request to be handled. In some examples, the user input may be specific to one or more operations, or one or more tasks related to any of the various domains and applications.

Upon receiving the user input, the orchestration engine 218 identifies and classifies 404 an intent of the user based on the user input. Identification and classification of the intent of the user input is described in detail along with the intent analysis module 306 of the orchestration engine 218 in FIG. 3, therefore repeated description is omitted herein for sake of brevity. Based on the identified and classified intent of the user, the orchestration engine 218 identifies 406 the sub-set of micro-agents, from the set of micro-agents 108 (depicted in FIG. 2), an orchestration, and instructions for handling the request specified in the user input. The sub-set of micro-agents, the orchestration, and the instructions may be identified based on the intent of the user, the request specified in the user input, the agent information about each micro-agent in the set of micro-agents 108. The agent information about each micro-agent may be accessed from the agent database 204 (depicted in FIG. 2). The sub-set of micro-agents may include one or more micro-agents from the set of micro-agents 108. The orchestration may indicate an order for executing the sub-set of micro-agents. The instructions may provide the agent information about each agent in the sub-set of micro-agents for execution.

Once the sub-set of micro-agents, the orchestration, and the instructions are identified, the execution engine 220 executes 408 the sub-set of micro-agents to generate respective one or more sub-responses. The sub-set of micro-agents may be executed to generate the one or more sub-responses by performing the one or more operations specific to the request specified in the user input, thereby processing the request. The one or more sub-responses may be used to generate a response.

In some examples, the execution engine 220 may execute the sub-set of micro-agents based on the orchestration and the instructions. By way of non-limiting example, as depicted in FIG. 4, the orchestration may indicate a sequential execution 410a, a parallel asynchronous execution 410b, a single instance execution 410c, and a function-based execution 410d for executing the sub-set of micro-agents. An example illustration 500 of executing the sub-set of micro-agents based on an orchestration 504 is depicted in FIG. 5.

As depicted in FIG. 5, consider that the sub-set of micro-agents identified for handling a request specified in a user input 502 includes the micro-agents 108a-108n. In such a scenario, if the orchestration 504 indicates the sequential execution 410a, the execution engine 220 may execute the micro-agents 108a-108n in a sequential manner. For example, the execution engine 220 may access a micro-agent 108a from the set of micro-agents 108 to provide the user input 502 to the micro-agent 108a and execute the micro-agent 108a to generate an answer by processing the user input 502. The answer generated using the micro-agent 108a and/or the user input may be provided to a micro-agent 108b. The execution engine 220 may execute the micro-agent 108b to generate an answer by processing the answer of the micro-agent 108a and/or the user input and provide the answer generated using the micro-agent 108b and/or the user input to a micro-agent 108c. The execution engine 220 may iterate such a sequential execution process until reaching the micro-agent 108n. An answer generated using the micro-agent 108n may be considered as a sub-response or a response 506. Therefore, the sequential execution 410a may involve multiple linear passes or forwards of the user input and/or the sub-responses.

If the orchestration 504 indicates the parallel asynchronous execution 410b, the execution engine 220 may provide the user input to the micro-agent 108a and execute the micro-agent 108a to generate an answer by processing the user input. The execution engine 220 may provide the answer generated using the micro-agent 108a and/or the user input to micro-agents 108b-108n-1 and execute the micro-agents 108b-108n-1 in parallel to generate respective answers or sub-responses. The answers or sub-responses generated using the micro-agents 108b-108n-1 may be provided to the micro-agent 108n, which may consolidate or combine the sub-responses as the response 506. Therefore, the parallel asynchronous may involve multiple parallel passes or forwards of the user input and/or the sub-responses.

If the orchestration 504 indicates the single instance execution 410c, the execution engine 220 may provide the user input to the micro-agents 108a-108n and execute the micro-agents 108a-108n at a time to generate sub-responses. The sub-responses may be considered as the response 506. Therefore, the single instance execution may involve a single pass of the user input.

If the orchestration 504 indicates the function-based execution 410d, the execution engine 220 may invoke the micro-agents 108a-108n as functions under a pre-defined function loop to generate respective sub-responses. The sub-responses may be combined or consolidated to generate the response 506.

Referring back to FIG. 4, once the response is generated by executing the sub-set of micro-agents, the response evaluation engine 222 evaluates 412 the response with an anticipated response or the user input and determines whether evaluation of the response meets or exceeds the predetermined threshold criterion (described in detail along with the evaluation module 320 of the response evaluation engine 222 in FIG. 3). Once the evaluation is performed, the response evaluation engine 222 determines 416 whether the status of evaluation is “success” or “failure.” When it has been determined that evaluation of the response meets or exceeds the predetermined threshold criterion, the response evaluation engine 222 determines the status of evaluation as “success.” When it has been determined that evaluation of the response fails to meet or exceed the predetermined threshold criterion, the response evaluation engine 222 determines the status of evaluation as “failure.” If the status of evaluation is “success,” the response evaluation engine 222 provides 418 the response as an output or a final output to the user input.

If the status of evaluation is “failure,” the response evaluation engine 222 generates 420 feedback. The feedback may indicate a reason for determining the status of evaluation as “failure” and the inputs for refining the response. Further, the response evaluation engine 222 iteratively performs step of:
(i) enabling the orchestration engine 218 to reidentify and reclassify the intent of the user based on the user input, and identify a new sub-set of micro-agents (e.g., including one or more other micro-agents from the set of micro-agents 108), a new orchestration, and new instructions based on the feedback;
(ii) enabling the execution engine 220 to execute the new sub-set of micro-agents to generate a new response by performing the one or more operations specific to the request; and
(iii) evaluating the new response and accordingly determining the status of evaluation as “success” or “failure.” The response evaluation engine 222 may iteratively performs such steps for a predefined number of iterations or until determining the status of evaluation as ‘success.”

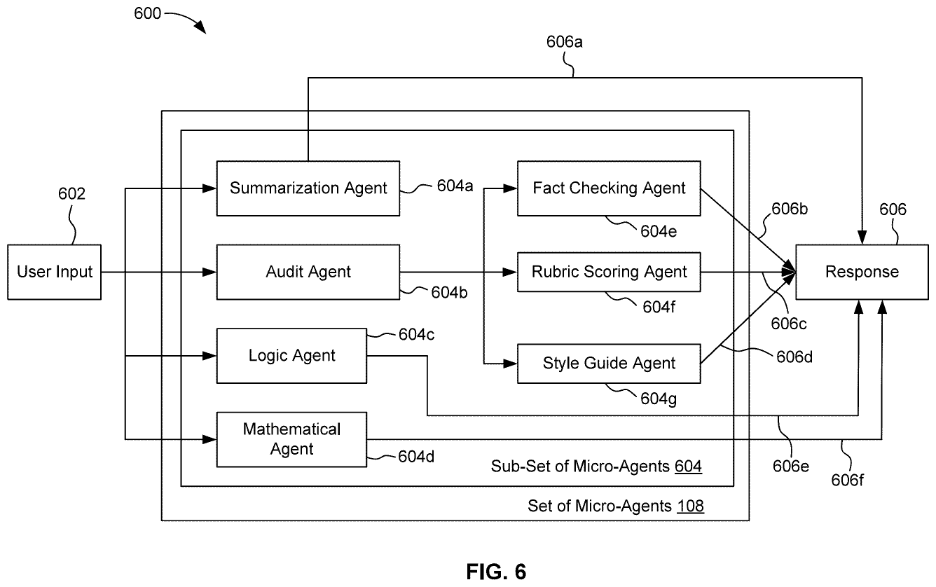

FIG. 6 depicts an example illustration 600 of handling the request using the sub-set of micro-agents, in accordance with implementations of the present disclosure.

As depicted in FIG. 6, consider that the distributed agentic system 102 (as described in relation to FIGS. 1-3) maintaining the set of micro-agents 108 receives a user input 602. The user input may include:
Request specific to an operation like “Auditing the given question and answer”
Question: “How to make pan cakes?”
Answer: “Pan cakes are best made in evenings. You can make pancakes by combining milk, eggs, and plain flour. Pan cakes should be cooked in butter. Pancakes are best served with chocolate spread.”

The request may indicate auditing the question and the respective answer (e.g., a prompt-response pair) for factual accuracy, conformance to a pre-defined rubric, and conformance to a pre-defined style guide. In such a scenario, the distributed agentic system 102 may identify a sub-set of micro-agents 604 from the set of micro-agents 108 for handling the request specified in the user input 602. The sub-set of micro-agents 604 may include seven micro-agents such as a summarization agent 604a, an audit agent 604b, a logic agent 604c, a mathematical agent 604d, a fact checking agent 604c, a rubric scoring agent 604f, and a style guide agent 604g. As would be understood, the summarization agent 604a, the audit agent 604b, the logic agent 604c, the mathematical agent 604d, the fact checking agent 604e, the rubric scoring agent 604f, and the style guide agent 604g are analogous to seven micro-agents of the micro-agents 108a-108n (depicted in FIG. 2) included in the set of micro-agents 108.

The summarization agent 604a may be executed to generate a sub-response 606a, which may summarize preparation or making of pan cakes. The audit agent 604b may be executed to provide audit data based on the user input. Following the execution of the audit agent, the fact checking agent 604c, the rubric scoring agent 604f, and the style guide agent 604g may be executed in parallel for generating a sub-response 606b, a sub-response 606c, and a sub-response 606d, respectively, based on the audit data. The sub-response 606b generated using the fact checking agent 604e may determine whether the answer provided for making the pan cakes includes any untruths. The sub-response 606c generated using the rubric scoring agent 604f may indicate a rubric score computed for the user input including the question and answer. The sub-response 606d generated using the style guide agent 604g may determine whether or how well the user input conforms to a predefined style guide. The logic agent 604c may be executed to generate a sub-response 606e, which may indicate detailed steps for preparing or making the pan cakes. The mathematical agent 604d may be executed to generate a sub-response 606f, which may indicate proportion or composition of ingredients required for preparing or making the pan cakes. In some examples, the summarization agent 604a, the audit agent 604b, the logic agent 604c, the rubric scoring agent 604f, and the style guide agent 604g may invoke or prompt the models 206 from the model database 207 (depicted in FIGS. 2 and 3) including the LLMs during the execution. The fact checking agent 604c may invoke one of the models 206 like a non-LLM based tool during its execution. The mathematical agent 604d may not invoke any of the models 206 during its execution.

The distributed agentic system 102 may combine or consolidate the sub-response 606a, the sub-response 606c, the sub-response 606c, the sub-response 606d, the sub-response 606e, and the sub-response 606f to generate a response 606. In an example herein, consider that the response 606 may be associated with the status of evaluation as “success”. Therefore, the distributed agentic system 102 may provide the response 606 as a final output to the user input 602. By way of non-limiting example, the response 606 may indicate the rubric score of ‘2’ for the user input and include the output as “The answer contains some information about pancake ingredients, but it does not provide a detailed step-by-step process for making pancakes. Additionally, the statement about pancakes being best made in the evenings is subjective and may not apply to everyone. To improve the answer, consider providing more specific instructions on how to make pan cakes, including measurements, cooking times, and temperature settings. Also, avoid adding personal opinions or preferences that may not be universally applicable. The best proposition of ingredients includes 0.5 litre milk, 2 eggs, and 100 g flour. Steps to prepare the pan cakes includes A, B, C, D . . . ”

Therefore, the distributed agentic system 102 may enable time and resource efficient auditing of questions and respective answers (e.g., prompt-response pairs). In some examples, the distributed agentic system 102 may use the questions and the respective answers for fine-tuning of the LLMs (depicted in FIG. 2) that are being accessed by the one or more micro-agents. By way of non-limiting example, the distributed agentic system 102 may use learning methods such as few-shot learning, instruction learning, and/or the like, for fine-tuning of the LLMs.

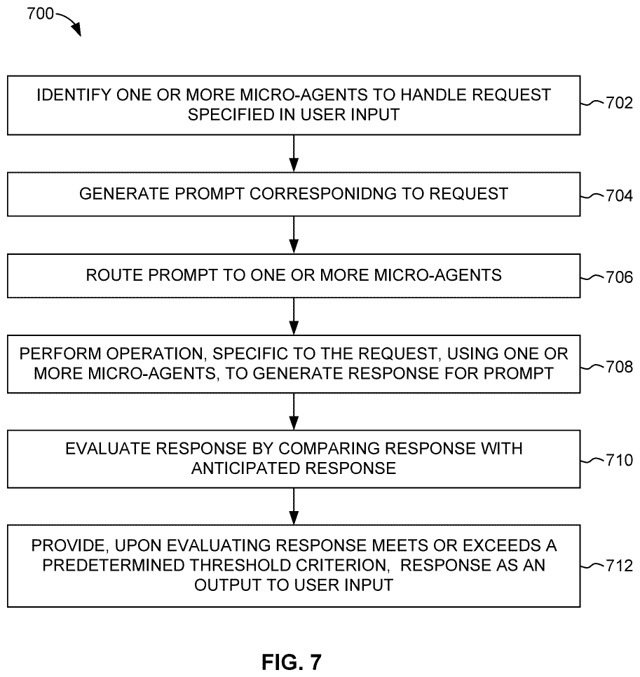

FIG. 7 is a flow diagram that presents an example computer implemented method 700 for handling requests using the distributed agentic framework, in accordance with implementations of the present disclosure. In some implementations, the method 700 may be executed by the processor 210 (including the one or more processors) of the distributed agentic system 102, as described in relation to FIGS. 1-6. The distributed agentic system 102 may employ the distributed agentic framework including the set of micro-agents 108 (depicted in FIGS. 1 and 2), wherein each micro-agent in the set of micro-agents 108 is configured to perform a specific operation.

The method 700 includes identifying 702 one or more micro-agents (e.g., a sub-set of micro-agents) from the set of micro-agents 108 to handle a request. The request is specified in a user input. In some examples, for identifying 702 the one or more micro-agents, the method 700 includes identifying and classifying the intent of the user based on the user input. Based on the intent of the user, the method 700 includes identifying the one or more micro-agents for handling the request. Identification and classification of the intent of the user is described in detail in conjunction with FIG. 3, therefore repeated description is omitted herein for sake of brevity. In some examples, if none of the micro-agents from the set of micro-agents 108 are available corresponding to the intent of the user, the method 700 includes generating a request for one or more new micro-agents that are configured to handle the request specified in the user input.

The method 700 includes generating 704 a prompt corresponding to the request specified in the user input. Upon generating the prompt, the method 700 includes routing 706 the prompt to the identified one or more micro-agents. The prompt may include one or more prompts corresponding to the one or more micro-agents.

The method 700 includes performing 708 one or more operations, specific to the request, using the respective one or more micro-agents, to generate a response for the prompt. In some examples, for performing 708 the one or more operations, the method 700 may include executing the one or more micro-agents to generate respective one or more intermediate answers by processing the prompt. The prompt may include the user input, names or identifiers of the one or more micro-agents, and an orchestration and instructions for executing the micro-agents. Based upon the one or more intermediate answers, the method 700 may include generating the response for the request specified in the user input. Generation of the response is described in detail in conjunction with FIG. 4, therefore repeated description is omitted herein for sake of brevity.

The method 700 includes evaluating 710 the response by comparing the response with an anticipated response. In some examples, the anticipated response may include a default response generated based on the user input. In some examples, evaluating 710 the response may include evaluating the response for fact checking, style guide criteria matching, and/or computing a rubric score for the response. Upon evaluating that the response meets or exceeds a predetermined threshold criterion, the method 700 includes providing 712 the response an output to the user input. Evaluation of the response is described in detail in conjunction with FIG. 4, therefore repeated description is omitted herein for sake of brevity.

In some examples, upon evaluating that the response fails to meet or exceed the predetermined threshold criterion, the method 700 may include identifying one or more other micro-agents from the set of micro-agents 108 to handle the request specified in the user input. The method 700 may further include performing the one or more operations using the one or more other micro-agents to generate a new response and evaluating the new response by comparing the new response with the anticipated response. Upon evaluating that the new response meets or exceeds the predetermined threshold criterion, the method 700 may include providing the new response as the output to the user input. In some examples, the method 700 may include updating the prompt for the request with respect to the one or more new micro-agents using a RAG process. The RAG process may enable updating the prompt based upon historical chat transcription and multiple fine-tuned Llama 2 model parameters stored in a database (e.g., the internal database 224 depicted in FIGS. 2 and 3) and a persistent memory (e.g., the memory 212 depicted in FIG. 2).

Implementations of the present disclosure provide technical solutions to multiple technical problems that arise in the context of handling requests specific to operations using a monolithic agentic framework. Implementations of the present disclosure provide a distributed agentic framework where the requests specific to the operations may be handled by decomposing each of the operations into sub-operations and engineering the sub-operations as respective individual micro-agents. Such a decomposition may aid in performing the operations by following a simple step by step operation lists, which may improve accuracy and reliability of outputs generated for the operations. For example, consider an operation like auditing or grading of a user input received from a user using various criteria. In such a scenario, the reliability of auditing or grading the user input using the monolithic agentic framework may degrade while approaching, for example, less than 60% successful execution. In contrast to the monolithic agentic framework, the reliability of auditing or grading the user input using the distributed agentic framework may be improved, while approaching, for example, more than 90% successful execution. Further, the distributed agentic framework may become more resilient to “unknown” user inputs (e.g., user inputs that has not been tested on), as the micro-agents are configured to handle one specific operation at a time. Therefore, a tendency of each of the micro-agents to deviate from a specified request or hallucinations of each of the micro-agents (which may be described as errors, inaccuracies, and/or untruths in an output) may be reduced. In addition, each of the micro-agents may access any fine-tuned models (e.g., LLM models) for performing a respective operation, which may allow high prioritized operations to be performed to a designated purpose without compromising other required skills such as classification, response generation, and user interaction.

Implementations of the present disclosure may enable sharing of a memory between the micro-agents and other components of the distributed agentic framework. Such a memory sharing may maintain a memory state ensuring a holistic user experience despite the multitude of components involved in the distributed agentic framework.

Implementations of the present disclosure further identify the micro-agents for the respective operations, identify an orchestration directing execution or processing of the micro-agents, and generate a response for the user input by performing the operations based on execution the respective micro-agents using the orchestration. Due to the orchestration, a total number of tokens present in prompts provided for the micro-agents may be reduced, which may further result in speedy or faster execution or processing of the micro-agents and may improve performance of the distributed agentic framework. Further, using the orchestration, the micro-agents may be executed or processed without requiring any additional computing resources (e.g., processing resources, memory resources, communication resources, and/or the like) to generate the response. Therefore, the response may be generated without any delay.

Implementations of the present disclosure further provide a self-evaluation framework for evaluating the response generated using the micro-agents and accordingly correcting any flaws or errors monitored from the evaluation of the response. Therefore, using the distributed agentic framework, the response with high accuracy and quality may be generated with reduced time and computing resources.

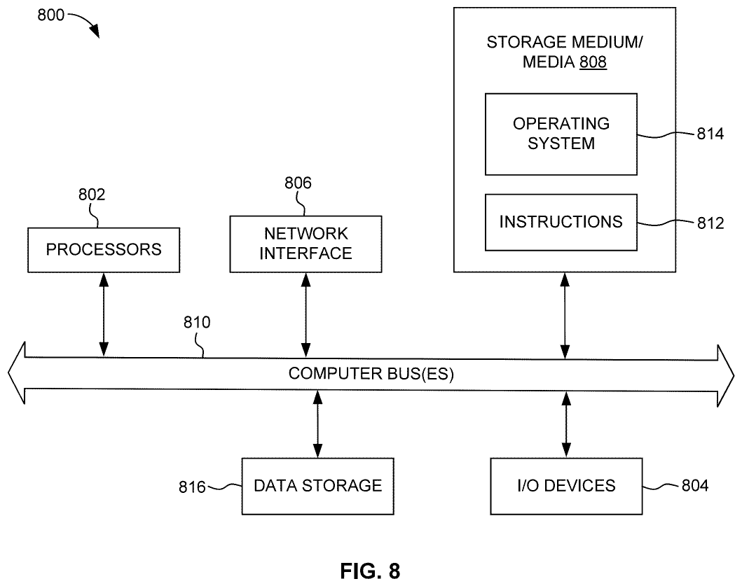

FIG. 8 depicts a computer system 800 that may be used to implement the distributed agentic system 102 disclosed in the example environment of FIG. 1. More particularly, computing machines such as desktops, laptops, smartphones, tablets, and wearables which may be used for handling the request using one or more micro-agents in the set of micro-agents. The computer system 800 may include additional components not shown and that some of the process components described may be removed and/or modified. In another example, a computer system 800 may be deployed on external-cloud platforms such as cloud, internal corporate cloud computing clusters, organizational computing resources, and/or the like.

The computer system 800 includes processor(s) 802 such as, a central processing unit, ASIC or another type of processing circuit, input/output devices 804 such as, a display, mouse keyboard, etc., a network interface 806 such as, a Local Area Network (LAN), a wireless 802.11x LAN, a 3G or 4G mobile WAN or a WiMax WAN, and a storage medium or media 808 (also be referenced to as computer-readable medium (CRM)). Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium such as, a magnetic disk or solid-state non-volatile memory or volatile medium such as RAM. The instructions or modules stored on the computer-readable medium 808 may include machine-readable instructions 812 executed by the processor(s) 802 that cause the processor(s) 802 to perform the methods and functions of the distributed agentic system 102.

The distributed agentic system 102 may be implemented as software stored on a non-transitory processor-readable medium and executed by the processor(s) 802. For example, the computer-readable medium 808 may store an operating system 814 such as, MAC OS, MS WINDOWS, UNIX, or LINUX, and code, for the distributed agentic system 102. The operating system 814 may be multi-user, multiprocessing, multitasking, multithreading, real-time, and the like. For example, during runtime, the operating system 814 is running and the code for the distributed agentic system 102 is executed by the processor(s) 802.

The computer system 800 may include a data storage 816, which may include non-volatile data storage. The data storage 816 stores any data used or generated by the distributed agentic system 102.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
identifying, by one or more processors of at least one computing device, at least one micro-agent of a plurality of micro-agents to handle a request, wherein the request is specified in a user input;
generating, by the one or more processors, a prompt corresponding to the request specified in the user input;
routing, by the one or more processors, the prompt to the at least one micro-agent of the plurality of micro-agents;
performing, by the one or more processors, at least one operation, specific to the request, using the at least one micro-agent of the plurality of micro-agents, to generate a response for the prompt;
evaluating, by the one or more processors, the response by comparing the response with an anticipated response; and
providing, by the one or more processors, upon evaluating the response meets or exceeds a predetermined threshold criterion, the response as an output to the user input.

2. The computer-implemented method of claim 1, wherein to identify the at least one micro-agent of the plurality of micro-agents the computer-implemented method further comprises:
analyzing and classifying, based on the user input, an intent of a user; and
determining, based on the intent of the user, the at least one micro-agent of the plurality of micro-agents.

3. The computer-implemented method of claim 2, further comprising upon determining that none of the plurality of micro-agents is available that corresponds with the intent of the user, generating a request for a new micro-agent that is configured to handle the request specified in the user input.

4. The computer-implemented method of claim 1, wherein performing the at least one operation specific to the request comprises:
processing the prompt using the at least one micro-agent of the plurality of micro-agents to generate at least one intermediate answer that corresponds with the prompt; and
generating, based upon the at least one intermediate answer, the response for the request specified in the user input.

5. The computer-implemented method of claim 1, wherein evaluating the response comprises evaluating the response for fact checking, style guide criteria matching, and/or computing a rubric score for the response.

6. The computer-implemented method of claim 1, further comprising performing, by the one or more processors, upon evaluating the response fails to meet or exceed the predetermined threshold criterion, one or more of:
identifying at least one other micro-agent of the plurality of micro-agents to handle the request specified in the user input;
performing, by the one or more processors, at least one operation using the at least one other micro-agent of the plurality of micro-agents to generate a new response;
evaluating, by the one or more processors, the new response by comparing the new response with the anticipated response; and/or
providing, by the one or more processors, upon evaluating the new response meets or exceeds the predetermined threshold criterion, the new response as the output to the user input.

7. The computer-implemented method of claim 6, further comprising updating the prompt corresponding to the request specified in the user input using a retrieval augmented generation (RAG) process.

8. The computer-implemented method of claim 7, wherein updating the prompt using the retrieval augmented generation (RAG) process further comprises updating the prompt based upon historical chat transcription and a plurality of fined-tuned Llama 2 model parameters stored in a database or a persistent memory.

9. A system comprising:
at least one memory configured to store machine-executable instructions; and
at least one processor communicatively coupled with the at least one memory, and configured to execute the machine-executable instructions to:
identify at least one micro-agent of a plurality of micro-agents to handle a request, wherein the request is specified in a user input;
generate a prompt corresponding to the request specified in the user input;
route the prompt to the at least one micro-agent of the plurality of micro-agents;
perform at least one operation, specific to the request, using the at least one micro-agent of the plurality of micro-agents, to generate a response for the prompt;
evaluate the response by comparing the response with an anticipated response; and
provide upon evaluating the response meets or exceeds a predetermined threshold criterion, the response as an output to the user input.

10. The system of claim 9, wherein to identify the at least one micro-agent of the plurality of micro-agents, the at least one processor is further configured to:
analyze and classify, based on the user input, an intent of a user; and
determine, based on the intent of the user, the at least one micro-agent of the plurality of micro-agents.

11. The system of claim 10, wherein the at least one processor is further configured to, upon determining that none of the plurality of micro-agents is available that corresponds with the intent of the user, generate a request for a new micro-agent that is configured to handle the request specified in the user input.

12. The system of claim 9, wherein to perform the at least one operation specific to the request, the at least one processor is further configured to:
processing the prompt using the at least one micro-agent of the plurality of micro-agents to generate at least one intermediate answer that corresponds with the prompt; and
generating, based upon the at least one intermediate answer, the response for the request specified in the user input.

13. The system of claim 9, wherein to evaluate the response, the at least one processor is further configured to evaluate the response for fact checking, style guide criteria matching, and/or compute a rubric score for the response.

14. The system of claim 9, wherein to perform the at least one operation specific to the request, the at least one processor is further configured to perform, upon evaluating the response fails to meet or exceed the predetermined threshold criterion, one or more of:
identifying at least one other micro-agent of the plurality of micro-agents to handle the request specified in the user input;
performing, by the one or more processors, at least one operation by the at least one other micro-agent of the plurality of micro-agents to generate a new response;
evaluating, by the one or more processors, the new response by comparing the new response with the anticipated response; and/or
providing, by the one or more processors, upon evaluating the new response meets or exceeds the predetermined threshold criterion, the new response as the output to the user input.

15. The system of claim 14, wherein the at least one processor is further configured to update the prompt corresponding to the request specified in the user input using a retrieval augmented generation (RAG) process.

16. The system of claim 15, wherein to update the prompt using the retrieval augmented generation (RAG) process, the at least one processor is further configured to update the prompt based upon historical chat transcription and a plurality of fined-tuned Llama 2 model parameters stored in a database or a persistent memory.

17. A non-transitory computer-readable media (CRM) comprising machine-executable instructions stored thereon, which, when executed by at least one processor of at least one computing device, cause the at least one computing device to:
identify at least one micro-agent of a plurality of micro-agents to handle a request, wherein the request is specified in a user input;
generate a prompt corresponding to the request specified in the user input;
route the prompt to the at least one micro-agent of the plurality of micro-agents;
perform at least one operation, specific to the request, using the at least one micro-agent of the plurality of micro-agents, to generate a response for the prompt;
evaluate the response by comparing the response with an anticipated response; and
provide upon evaluating the response meets or exceeds a predetermined threshold criterion, the response as an output to the user input.

18. The non-transitory CRM of claim 17, wherein to identify the at least one micro-agent of the plurality of micro-agents, the machine-executable instructions, which, when executed by at least one processor of at least one computing device, further cause the at least one computing device to:
analyze and classify, based on the user input, an intent of a user; and
determine, based on the intent of the user, the at least one micro-agent of the plurality of micro-agents,
wherein the at least one processor is further configured to, upon determining that none of the plurality of micro-agents is available that corresponds with the intent of the user, generate a request for a new micro-agent that is configured to handle the request specified in the user input.

19. The non-transitory CRM of claim 17, wherein to perform the at least one operation specific to the request, the machine-executable instructions, which, when executed by at least one processor of at least one computing device, further cause the at least one computing device to:
processing the prompt using the at least one micro-agent of the plurality of micro-agents to generate at least one intermediate answer that corresponds with the prompt; and
generating, based upon the at least one intermediate answer, the response for the request specified in the user input.

20. The non-transitory CRM of claim 17, wherein to evaluate the response, the machine-executable instructions, which, when executed by at least one processor of at least one computing device, further cause the at least one computing device to evaluate the response for fact checking, style guide criteria matching, and/or compute a rubric score for the response.
